(19) United States
(12) Patent Application Publication
(10) Pub. No.: US 2016/0162472 A1
(43) Pub. Date: Jun. 9, 2016

(54) METHOD AND APPARATUS FOR PROVIDING ALTERNATIVE CONTENT

(71) Applicant: HERE Global B.V., Veldhoven (NL)

(72) Inventor: James D. LYNCH, Chicago, IL (US)

(21) Appl. No.: 14/560,915

(22) Filed: Dec. 4, 2014

(51) Int. Cl. G06F 17/27; G06F 3/0484

(52) U.S. Cl. CPC G06F 17/2795; G06F 3/0484

(57) ABSTRACT

An approach is provided for providing alternative content based on interaction input. The alternative content platform determines at least one interaction input associated with textual content presented on at least one device. The alternative content platform further determines one or more alternative textual content based, at least in part, on one or more properties of the at least one interaction input. The alternative content platform also causes, at least in part, a presentation of one or more alternative textual content in at least one user interface of the at least one device.

### BACKGROUND

Service providers and device manufacturers (e.g., wireless, cellular, etc.) are continually challenged to deliver content and convenience to consumers. One area of interest has been providing content and related applications. However, users typically need to access an external program or multiple commands to receive alternative content. Accordingly, service providers and device manufacturers face significant technical challenges to providing alternative content.

### SOME EXAMPLE EMBODIMENTS

Therefore, there is a need for an approach for providing alternative content based on at least one interaction input.

According to one embodiment, a method comprises determining at least one interaction input associated with textual content presented on at least one device. The method also comprises determining one or more alternative textual content based, at least in part, on one or more properties of the at least one interaction input. The method further comprises causing, at least in part, a presentation of one or more alternative textual content in at least one user interface of the at least one device.

According to another embodiment, an apparatus comprises at least one processor, and at least one memory including computer program code for one or more computer programs, the at least one memory and the computer program code configured to, with the at least one processor, cause, at least in part, the apparatus to determine at least one interaction input associated with textual content presented on at least one device. The apparatus is also caused to determine one or more alternative textual content based, at least in part, on one or more properties of the at least one interaction input. The apparatus is further caused to causing, at least in part, a presentation of one or more alternative textual content in at least one user interface of the at least one device.

According to another embodiment, a computer-readable storage medium carries one or more sequences of one or more instructions which, when executed by one or more processors, cause, at least in part, an apparatus to determine at least one interaction input associated with textual content presented on at least one device. The apparatus is also caused to determine one or more alternative textual content based, at least in part, on one or more properties of the at least one interaction input. The apparatus is further caused to a presentation of one or more alternative textual content in at least one user interface of the at least one device.

According to another embodiment, an apparatus comprises means for determining at least one interaction input associated with textual content presented on at least one device. The apparatus also comprises means for determining one or more alternative textual content based, at least in part, on one or more properties of the at least one interaction input. The apparatus further comprises means for causing, at least in part, a presentation of one or more alternative textual content in at least one user interface of the at least one device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing alternative content based on at least one interaction input, according to one embodiment;

FIG. 2 is a diagram of the components of the alternative content platform, according to one embodiment;

FIG. 3 is a flowchart of a process for presenting alternative content based on at least one interaction input, according to one embodiment;

FIGS. 4A-4C are diagrams of user interfaces utilized in the processes of FIG. 3, according to various embodiments;

FIGS. 5A and 5B are diagrams of user interfaces utilized in the processes of FIG. 3, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing alternative content based on at least interaction input are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

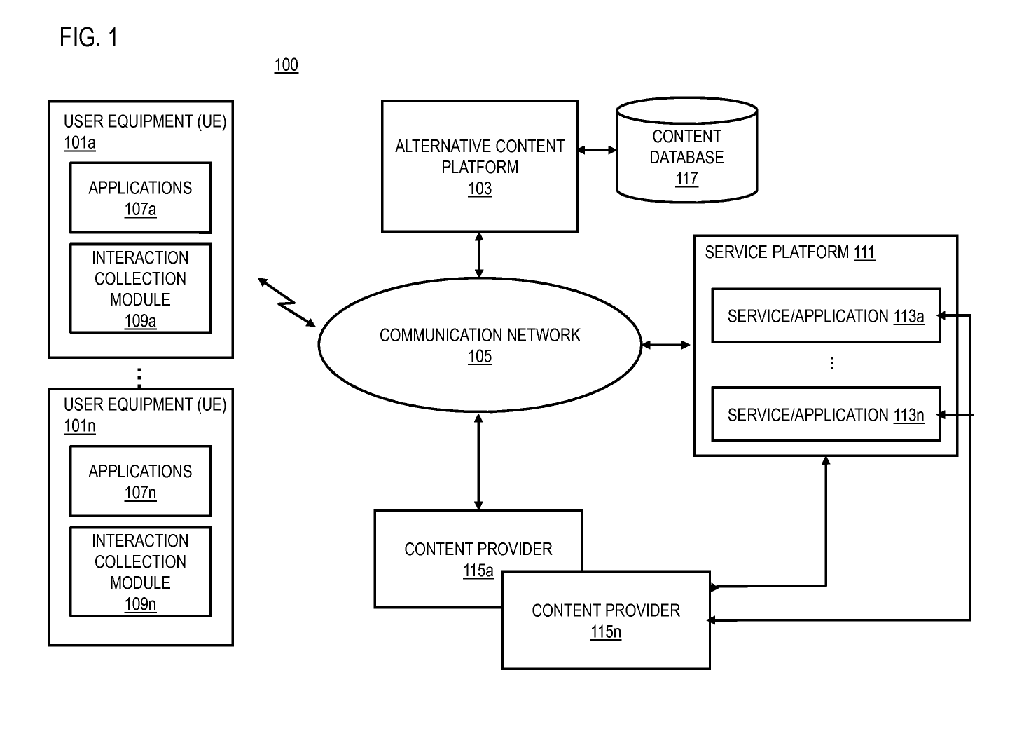

FIG. 1 is a diagram of a system capable of providing alternative textual content based on at least one interaction input, according to one embodiment. Traditionally, users can obtain alternative content, like different words (e.g., synonyms), using tools (e.g., accessed by commands) provided in the application or using separate applications and/or service sites. However, this can be inconvenient for users, for example, wanting alternative content in applications on their mobile devices.

To address this problem, a system 100 of FIG. 1 introduces the capability to providing alternative content in at least one user interface based on at least one interaction input. In one embodiment, the content and alternative content may include but is not limited to textual content (e.g., a word or phrase presented in a text and/or document), pictorial content (e.g., pictures representing an object, a player in an application, etc.), among others, or a combination thereof. As used herein, the term “alternative content” refers to content of a similar type (e.g., textual content, pictorial content, etc.) as the associated content having the same or similar idea that is represented by a word, phrase, picture, etc. For example, the alternative textual content may be a synonym of the associated content (e.g., word).

More specifically, the system 100 provides content on the user interface that is alternative to the content presented on at least one device. Interaction input includes but is not limited to a physical manipulation of the device (e.g., shaking the device), touch interaction (e.g., swiping over the associated content on the user interface in more than one direction), gesture interaction (e.g., performing the shaking interactions in front of the user interface), a voice interaction (e.g., a voice command to a word), a physical manipulation of the device (e.g., moving the device to cause the corresponding rotation), among others, or a combination thereof. For example, the system 100 presents synonyms for one or more words that are highlighted in a text message in the user interface based on at least one interaction input.

In one embodiment, the system 100 provides alternative content based on one or more properties of the at least one interaction input associated with content presented on a user device. The one or more properties may include but is not limited to a degree of at least one interaction input, a frequency of at least one interaction input, or a combination thereof. By way of example, for shaking and/or swiping motion over the content presented on at least one device, the properties may include but are not limited e.g., the number of shakes, the duration of shaking, the force of shaking (e.g., hard vs. soft), range of motion of shake(s), etc.

In one embodiment, the system 100 may process the one or more properties of the at least one interaction input to determine one or more attributes of the one or more alternative content, a number of one or more alternative content to present, or a combination thereof. The one or more attributes of alternative textual content may include, for example, a length of the one or more alternative textual content, the complexity of the one or more alternative textual content, or a combination thereof. For example, the system 100 may cause words in increasing complexity and/or length proportional to interaction input (e.g., increasing frequency, shakes, range of motion of shake, etc.). For example, in response to two shakes of a user interface presenting the word “good,” the system 100 may present “awesome.” In a further example, in response to four shakes of a user interface presenting the word “good”, the system 100 may present a word with more complexity than the two shakes, such as “stupendous.”

By way of another example, the system 100 may present more than one word. For example, the number of alternative words presented may correspond to the number of movements in a direction (e.g., a shake). For example, in response to two shakes, the system 100 may present two synonyms. In a further example, in response to four shakes, the system 100 may present three synonyms. In this way, the user can control the number and/or type of alternative content presented based on the interaction input.

A user may continue to interact with the user interface until they find presented alternative content that he/she likes. In the example above, the user may shake the user interface after seeing “awesome” until “stupendous” is displayed. In certain embodiments, the system 100 may be caused to present alternative textual content increasing complexity and/or length based on the number of continued interaction input associated with content.

In one embodiment, the system 100 may replace the content associated with the at least one interaction input with the alternative content. For example, the system 100 may replace “good” in the user interface with “awesome.” In certain embodiments, the system 100 may present the one or more alternative textual content above or below the content associated with the at least one interaction input individually and/or in a list. For example, the system 100 may present “awesome” above and/or below “good” in the user interface. In another example, the system 100 may present a list of more than two words (e.g., awesome, stupendous, etc.) above and/or below “good” in the user interface.

In one embodiment, the rendering of the alternative content may be based on user preference. For example, a user can indicate a preference for the presentation of the alternative content (e.g., as a list, location, replacement, etc.) with respect to the content associated with the at least one interaction input.

In one embodiment, the system 100 may replace the content associated with the at least one user interact input with the alternative content based on the user selecting the alternative content. For example, the user may select the alternative content from the list or may indicate that the alternative content replacing the content in the user interface is selected (e.g., by clicking the alternative content in the user interface).

As shown in FIG. 1, the system 100 comprises a user equipment (UE) 101 having connectivity to an alternative content platform 103 via a communication network 105. The UEs 101 may include or have access to an application 107 (or applications 107), which may consist of client programs, services, or the like, that may utilize the alternative content platform 103, or other services, applications, content, etc. available over the communication network 105. By way of example, the application 107 may be any type of application that is executable at the UE 101, such as messaging applications, word processing applications, media player applications, social networking applications, calendar applications, and the like.

In certain embodiments, the alternative content platform 103 of the UE 101 can determine and/or process interaction input associated with the interaction collection module 109. For example, the interaction collection module 109 may utilize applications, services, sensors, etc., to collect and/or detect such information associated with the at least one interaction input with the textual content. Information may include, for instance, location information, camera information, compass information, temporal information, accelerometer information, etc. The alternative content platform 103 may then process the user input to determine one or more properties of the at least one interaction input.

In one embodiment, the alternative content platform 103 can obtain content information for presenting as alternative content. The content information, for instance, includes alternative word(s) or phrase(s) (e.g., synonyms), pictures, etc., or a combination thereof. The content may be provided by the service platform 111 which includes one or more services 113a-113 n (e.g., mapping service, content broadcasting service, etc.), the one or more content providers 115 a-115 n (e.g., public databases, etc.), other content source available or accessible over the communication network 105. In one embodiment, content is delivered from the content providers 115 a-115 n to the UE 101 through the service platform 111 and/or the services 113 a-113 n. For example, a service 113 a may obtain content from a content provider 115 a to deliver as alternative content to the UE 101.

In one embodiment, the alternative content platform 103 can store the alternative content, for example, in a content database 117. For example, the one or more attributes of the alternative content may be stored with respect content in the content database 117.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the alternative content platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

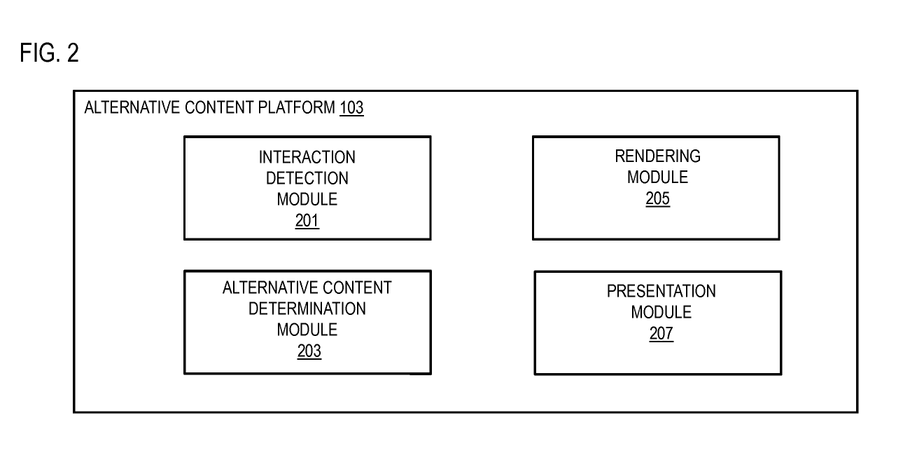

FIG. 2 is a diagram of the components of the alternative content platform 103, according to one embodiment. By way of example, the alternative content platform 103 includes one or more components for providing alternative content based on at least one interaction input. It is contemplated that the functions of these components may be combined in one or more components or performed by other components of equivalent functionality. In this embodiment, the alternative content platform 103 includes an interaction determination module 201, an alternative content determination module 203, a rendering module 205, and a presentation module 207.

The interaction determination module 201 can determine at least one interaction input associated with content presented on a least device. For example, the interaction determination module 201 can determine that a word has been highlighted and the device has been moved physically in direction(s) (e.g., shaken) or the highlighted word presented on at least one device has been moved in direction(s) (e.g., shaken) by a gesture input. In another example, the interaction determination module can determine that a picture has been highlighted and the device has been shaken physically or the picture presented on at least one device has been shaken by a gesture input.

In certain embodiments, the interaction determination module 201 can determine one or more properties associated with the at least one interaction input. For example, the interaction determination module 201 can determine the frequency of the movement, the force of the shaking, the duration of the movement, among others, or combination thereof, associated with the physical or gesture shaking of device and/or content.

The alternative content determination module 203 can determine one or more alternative content based, at least in part, on one or more properties of the at least one interaction input. In certain embodiments, the alternative content determination module 203 can process information regarding the one or more properties of the at least one interaction input to determine the alternative content. For example, the alternative content determination module 203 can determine one or more attributes (e.g., length of the one or more alternative content, a complexity of the one or alternative content, or a combination thereof), from the one or more properties associated with the at least one interaction input. The properties may be from a single or multiple interaction inputs. For example, the alternative content determination module 203 may provide a longer word or a more complex word for more movement (shaking) of the device, for larger range of motion when shaking, etc. By way of example, the alternative content determination module 203 may determine “enrage” as alternative textual content for textual content, “anger” based on a basic shake (shaking a few times) and may determine “exasperate” for “anger” based on a more vigorous shake. In this example, the more vigorous shake may indicate a longer word and/or more complex word. In another example, the alternative content determination module 203 can also determine “exasperate” after presenting “enrage” as alternative content based on further shaking. In certain embodiments, the relationship between properties and attributes may be based on user preference (e.g., the higher frequency the more complex the word).

In certain embodiments, the alternative content determination module 203 can determine more than one alternative content based on the properties. For example, for basic shaking, the alternative content determination module 203 can determine a single synonym for “anger,” and for a more vigorous shaking, the alternative content determination module can determine a plurality of synonyms for “anger.”

The rendering module 205 can cause a rendering of the one or more alternative content. In one embodiment, the rendering module 205 may render a single alternative content for presentation in the user interface. In certain embodiments, the rendering module 205 may render a list of one or more alternative textual content for presentation in the user interface. In certain embodiments, the rendering may be based on user preference.

The presentation module 207 can cause a presentation of the one or more alternative content in at least one user interface of the at least one device. In one embodiment, the presentation module 207 can cause the alternative content to replace the content presented on at least one device. In certain embodiments, the presentation module 207 can cause the alternative content to be displayed adjacent to or in proximately to a rendering of the content present on at least one device. For example, the presentation module 207 may present a synonym above or below the word, by itself, or with other synonyms of the words in a list. In certain embodiments, the presentation module 207 can determine a selection of at least one of the alternative content presented and cause the alternative content to replace the content presented on at least one device. By way of the example above, the presentation module 207 may replace the word with one of the synonyms selected by the user from the list and/or above or below the word.

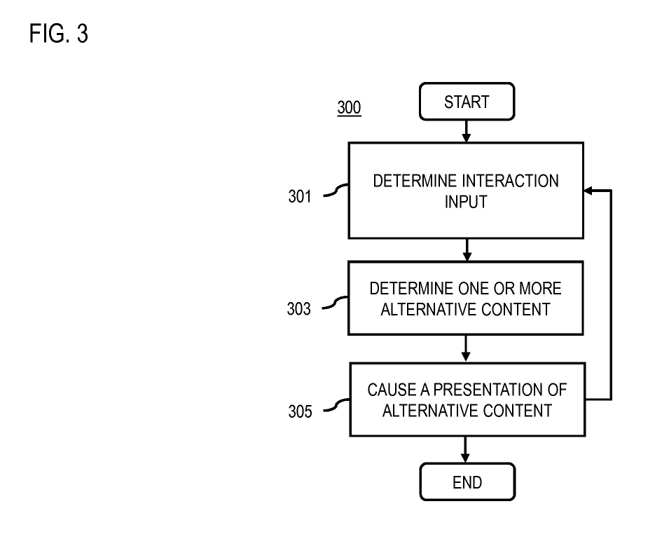

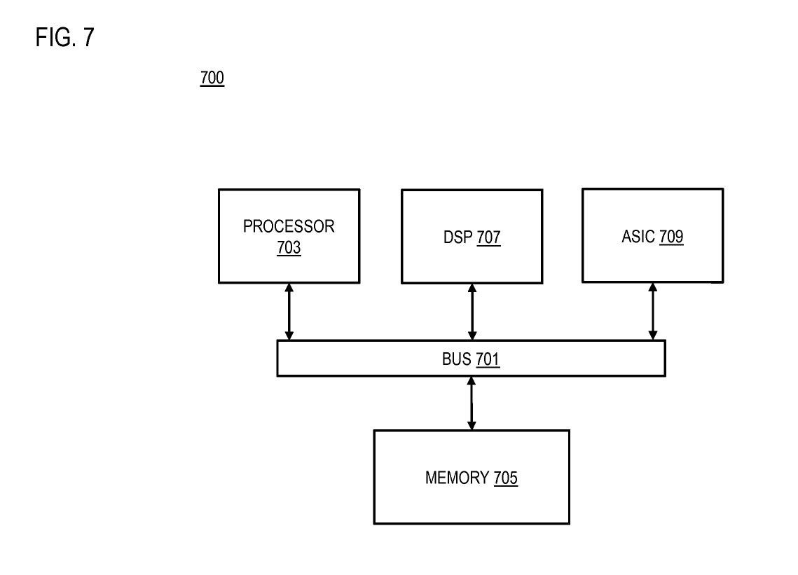

FIG. 3 is a flowchart of a process for providing alternative content, according to one embodiment. In one embodiment, the alternative content platform 103 and/or an application 107 of the UE 101 performs the process 300 and is implemented in, for instance, a chip set including a processor and a memory as shown in FIG. 7. Throughout this process, the alternative content platform 103 is referred to as completing various portions of the process 300, however it is understood that the UE 101 can perform some of and/or all of the process steps.

In step 301, the alternative content platform 103 determines an interaction input associated with content present at least one device. In one example, the alternative content platform 103 detects a word highlighted on the at least one device and moving the device, for example, in a shaking motion, and/or gesture movement, e.g., for example, in a shaking motion, of the word. In one embodiment, the alternative content platform 103 determines one or more properties of the at least one interaction input. For example, the alternative content platform 103 can determine a degree of the interaction, frequency of the interaction, or a combination thereof.

In certain embodiments, the alternative content platform 103 may determine the one or more properties of all interaction inputs associated with the content presented. For example, the alternative content platform 103 may determine the properties of multiple movements associated with the word presented on at least one device. By way of example, the user may have wanted to additional alternative content so the user may have shaken the device after one or more synonyms presented. The alternative content platform 103 may determine the one or more properties of the most recent and past shakes associated with the word presented on the device.

The alternative content platform 103 may then determine one or more alternative content based, at least in part, on one or more properties of the one interaction input (step 303). For example, the alternative content platform 103 determines a synonym and/or a number of synonyms based on the properties of the at least one interaction input. In certain embodiments, the alternative content platform can determine attributes of the alternative content, a number of alternative content to present, or a combination thereof based on the properties. For example, the alternative content platform can determine a complexity of the synonym, the length of the synonym, and/or a number of synonyms based on the degree of movement, the frequency of movement, or a combination thereof associated with the word. In this example, more or greater movement may result in longer and/or more complex words and/or more words presented. In certain embodiments, the one or more attributes of the alternative content may be associated with the one or more properties of the at least one interaction input based on user preference. For example, the user may indicate that the number of shakes may correspond to a higher complex word.

The alternative content platform 103 may cause a presentation of the one or more alternative content in at least one user interface of the at least one device (step 305). For example, the alternative content platform 103 may replace word highlighted in a document and/or message with a synonym. In certain embodiments, the alternative content platform 103 may present the synonym or a list of synonyms adjacent to or proximately to the word, for example, above or below. The alternative content platform 103 may cause one of the synonyms to replace the word when one of the synonyms is selected. In certain embodiments, the presentation of the one or more alternative content may be based on user preference.

In certain embodiments, the alternative content platform 103 may continuously determine interaction input and alternative content with respect to content until the user causes the alternative content platform 103 to stop. For example, the user may cause the alternative content platform 103 to stop determining and processing user interaction input when one of the alternative content or content is selected to replace or remain in the user interface.

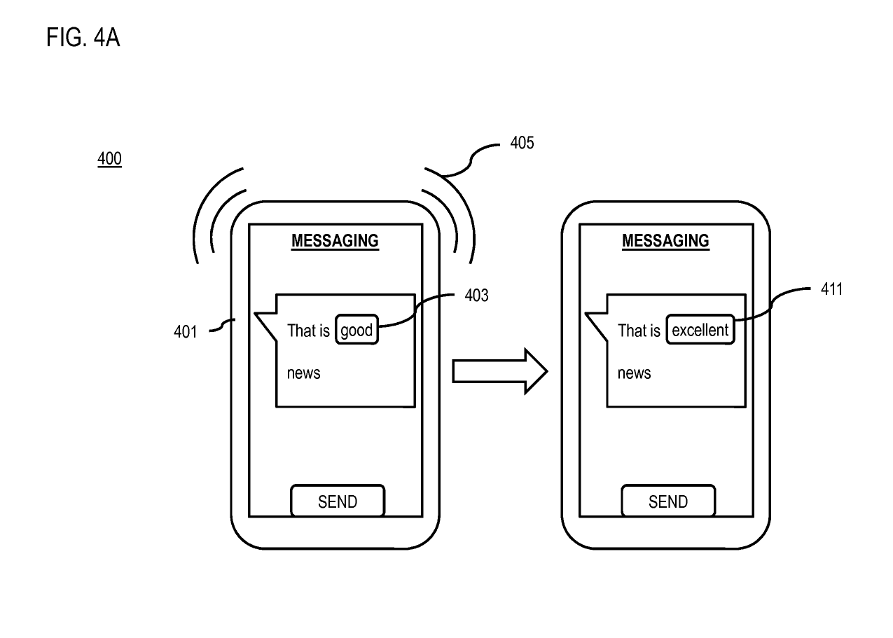

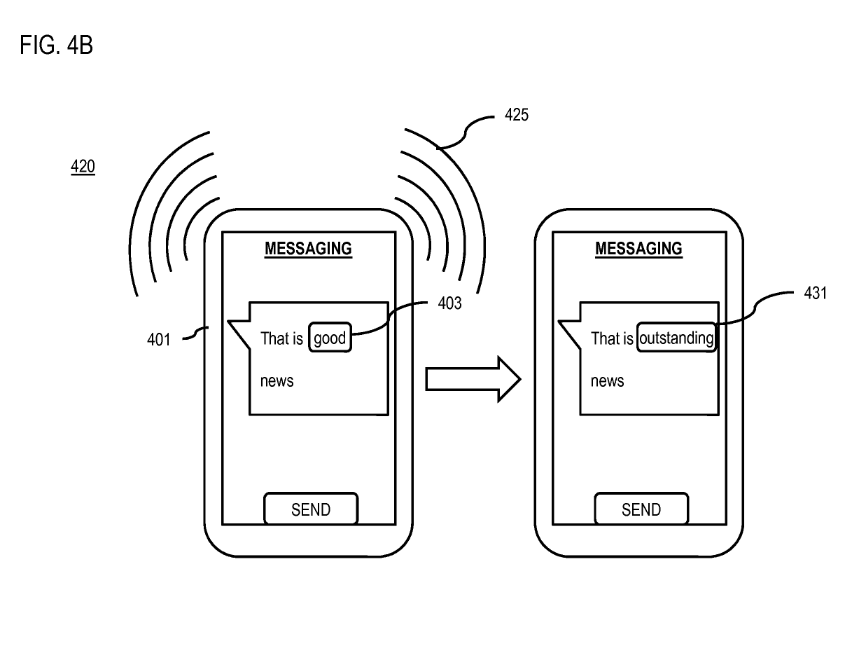

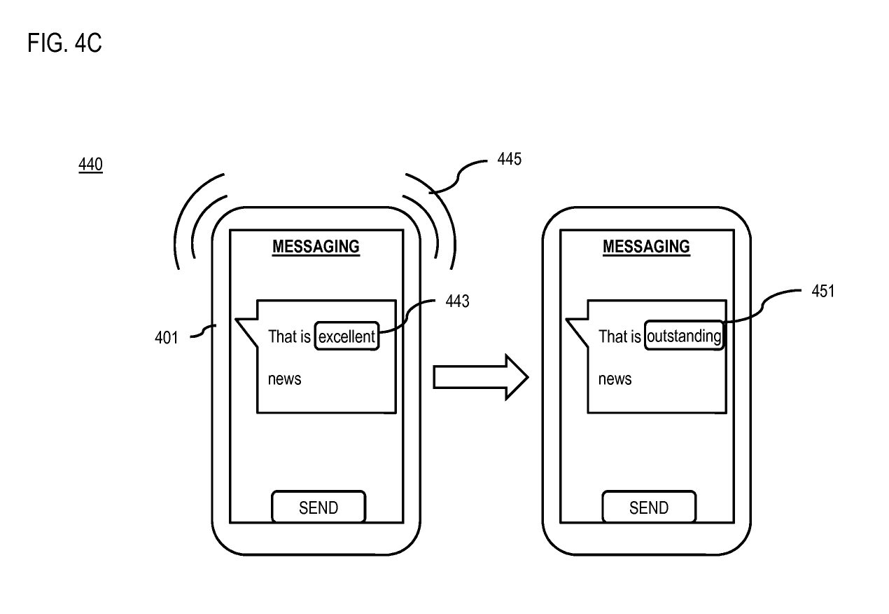

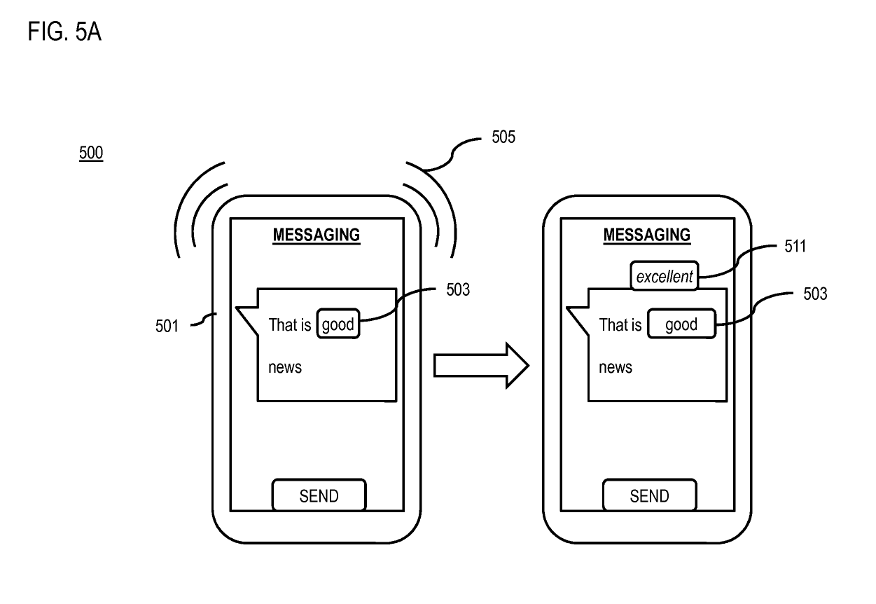

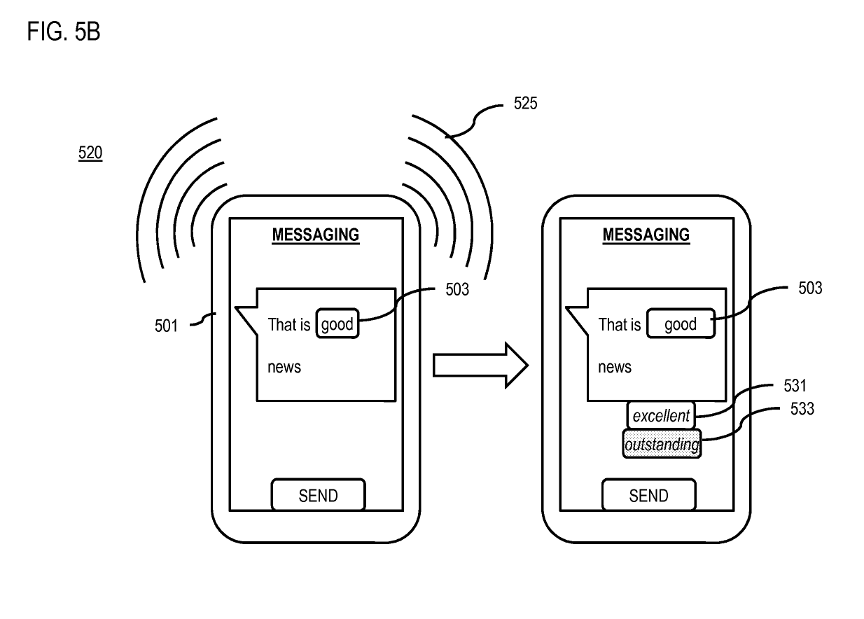

FIGS. 4A-5B are diagrams of user interfaces utilized in the processes of FIG. 3, according to various embodiments. FIGS. 4A-4C show examples of providing alternative content wherein the higher frequency of movement corresponds to more complex and/or longer synonyms. FIG. 4A shows an example 400 of interaction input 405 associated with the word “good” 403 in a user interface (e.g., messaging application) 401. In this example, the user has highlighted the word “good” and has caused the device to move or shake twice. The alternative content platform 103 processes the movement 405 and determines synonym “excellent” for the word good based on the properties of the movement 405. In this example, the alternative content platform 103 replaces “good” with “excellent” in the user interface.

FIG. 4B show an example 420 of interaction input 425 associated with the word “good” 403 in the user interface 401. In this example, the user has caused the device to move or shake four times. The alternative content platform 103 processes the movement 405 and determines a synonym that is more complex or longer than “excellent.” For example, the alternative content platform 103 determines synonym 431, “outstanding,” and replaces “good” with “outstanding” in the user interface.

FIG. 4C shows an example 430 of interaction input 445 associated with the word “excellent” 443 in the user interface 401. In this example, the presentation of content, “excellent,” resulted from the user shaking the device with respect to “good” as shown in FIG. 4A. The user has caused the device to move or shake an additional two times. The alternative content platform 103 processes the movement 445 and determines a synonym that is more complex or longer than “excellent” based on the movement 445 and movement 405. For example, the alternative content platform 103 determines synonym 431, “outstanding,” and replaces “excellent” with “outstanding” in the user interface.

FIGS. 5A and 5B show examples of providing alternative content adjacent to or proximately to a rendering of textual content in the user interface. FIGS. 5A and 5B show examples of providing alternative content wherein the higher frequency of movement corresponds to more synonyms being presented. FIG. 5A shows an example 500 of interaction input 505 associated with the word “good” 503 in a user interface (e.g., messaging application) 501. In this example, the user has highlighted the word “good” and has caused the device to move or shake twice. The alternative content platform 103 processes the movement 505 and determines synonym “excellent” 511 for the word good based on the properties of the movement 405. In this example, the alternative content platform 103 presents “excellent” in the user interface above the “good” 503.

FIG. 5B show an example 520 of interaction input 525 associated with the word “good” 503 in the user interface 401. In this example, the user has caused the device to move or shake four times. The alternative content platform 103 processes the movement 525 and determines a number of words more than example 500. For example, the alternative content platform 103 determines synonyms, “excellent” 531 and “outstanding” 533, and presents them as a list below and “good” 503 in the user interface. In this example, the user has selected the synonym “outstanding,” which result in the user interface example provided in FIG. 4B.

The processes described herein for providing alternative content based on at least one interaction input may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

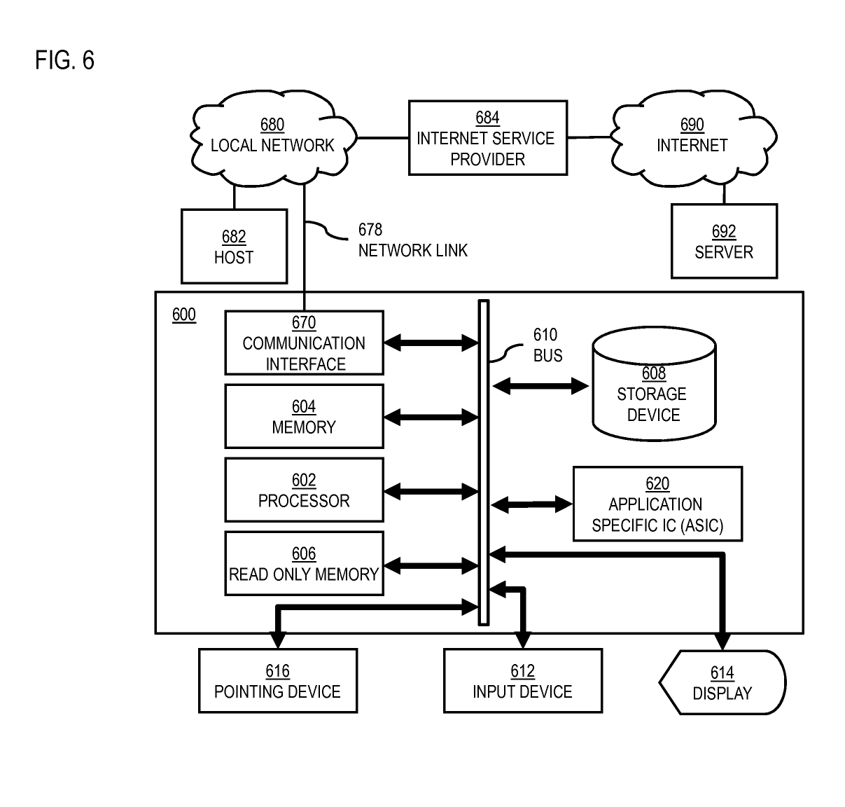

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide alternative content based on at least one interaction input as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing alternative content based on at least one interaction input.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing alternative content based on at least one interaction input. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing alternative content based on at least one interaction input. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing alternative content based on at least one interaction input, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing alternative content based on at least one interaction input to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide alternative content based on at least one interaction input as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing alternative content based on at least one interaction input.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide alternative content based on at least one interaction input. The memory 705 also stores the data associated with or generated by the execution of the inventive steps.

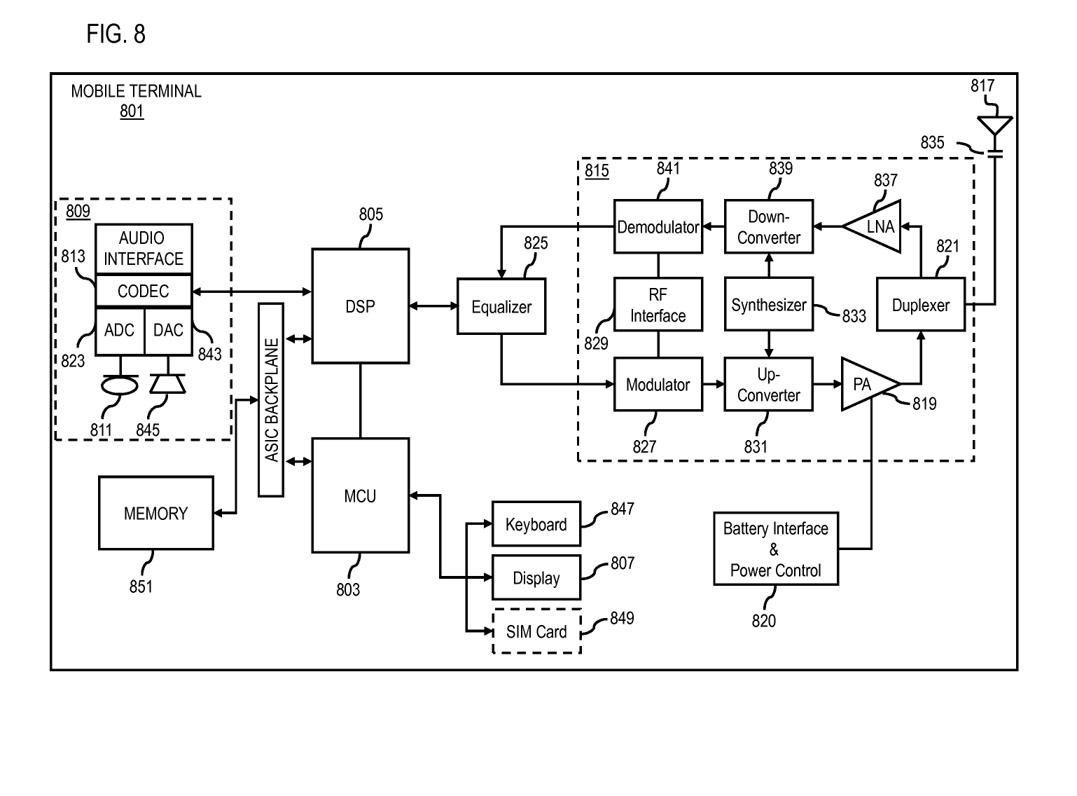

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing alternative content based on at least one interaction input. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing alternative content based on at least one interaction input. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide alternative content based on at least one interaction input. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although

1. A method comprising:
determining at least one interaction input associated with textual content presented on at least one device;
determining one or more alternative textual content based, at least in part, on one or more properties of the at least one interaction input; and
causing, at least in part, a presentation of one or more alternative textual content in at least one user interface of the at least one device.

2. A method of claim 1, wherein the at least one interaction input includes at least one movement of the at least one device, and wherein the one or more alternative textual content include, at least in part, one or more synonyms of the textual content.

3. A method of claim 2, wherein the at least one movement includes at least one shaking movement.

4. A method of claim 1, further comprising:
processing and/or facilitating a processing of information regarding the one or more properties of the at least one interaction input to determine one or more attributes of the one or more alternative textual content, a number of the one or more alternative textual content to present, or a combination thereof.

5. A method of claim 4, wherein the one or more attributes include, at least in part, a length of the one or more alternative textual content, a complexity of the one or more alternative textual content, or a combination thereof.

6. A method of claim 1, wherein the presentation of the one or more alternative textual content comprises:
causing, at least in part, a rendering of the one or more alternative textual content to replace the textual content in the at least one user interface.

7. A method of claim 1, wherein the presentation of the one or more alternative textual content comprises:
causing, at least in part, a presentation of the one or more alternative textual content adjacent or proximately to a rendering of the textual content in the user interface.

8. A method of claim 1, wherein the one or more properties of the at least one interaction input include, at least in part, a degree of at least one interaction input, a frequency of the at least one interaction input, or a combination thereof.

9. A method of claim 1, further comprising:
determining at least one other interaction input,
determining one or more other alternative textual content based, at least in part, on one or more properties of the at least one other interaction input; and
causing, at least in part, a presentation of the one or more other alternative textual content in the at least one user interface.

10. A method of claim 1, further comprising:
determining a selection of at least one selected content from among the one or more alternative textual content in the at least one user interface; and
causing, at least in part, a replacement of the textual content with the at least one selected content.

11. An apparatus comprising:
at least one processor; and
at least one memory including computer program code for one or more programs,
the at least one memory and the computer program code configured to, with the at least one processor, cause the apparatus to perform at least the following,
determine at least one interaction input associated with textual content presented on at least one device;
determine one or more alternative textual content based, at least in part, on one or more properties of the at least one interaction input; and
cause, at least in part, a presentation of one or more alternative textual content in at least one user interface of the at least one device.

12. An apparatus of claim 11, wherein the at least one interaction input includes at least one movement of the at least one device, and wherein the one or more alternative textual content include, at least in part, one or more synonyms of the textual content.

13. An apparatus of claim 12, wherein the at least one movement includes at least one shaking movement.

14. An apparatus of claim 11, wherein the apparatus is further caused to:
process and/or facilitate a processing of information regarding the one or more properties of the at least one interaction input to determine one or more attributes of the one or more alternative textual content, a number of the one or more alternative textual content to present, or a combination thereof.

15. An apparatus of claim 14, wherein the one or more attributes include, at least in part, a length of the one or more alternative textual content, a complexity of the one or more alternative textual content, or a combination thereof.

16. An apparatus of claim 11, wherein the presentation of the one or more alternative textual content further causes the apparatus to:
cause, at least in part, a rendering of the one or more alternative textual content to replace the textual content in the at least one user interface.

17. An apparatus of claim 11, wherein the presentation of the one or more alternative textual content further causes the apparatus to:
cause, at least in part, a presentation of the one or more alternative textual content adjacent or proximately to a rendering of the textual content in the user interface.

18. A computer-readable storage medium carrying one or more sequences of one or more instructions which, when executed by one or more processors, cause an apparatus to perform:
determining at least one interaction input associated with textual content presented on at least one device;
determining one or more alternative textual content based, at least in part, on one or more properties of the at least one interaction input; and
causing, at least in part, a presentation of one or more alternative textual content in at least one user interface of the at least one device.

19. A computer-readable storage medium of claim 18, wherein the at least one interaction input includes at least one movement of the at least one device, and wherein the one or more alternative textual content include, at least in part, one or more synonyms of the textual content.

20. A computer-readable storage medium of claim 18, wherein the apparatus is further caused to perform:
processing and/or facilitating a processing of information regarding the one or more properties of the at least one interaction input to determine one or more attributes of the one or more alternative textual content, a number of the one or more alternative textual content to present, or a combination thereof.

21-48. (canceled)
